(19) United States
(12) Patent Application Publication
(10) Pub. No.: US 2008/0004074 A1
(43) Pub. Date: Jan. 3, 2008

(54) Complex audio detection apparatus

(76) Inventors: Ming-Wei Wang, Dali City (TW); Hsiang-Lung Yu, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/476,167

(22) Filed: Jun. 28, 2006

(51) Int. Cl. H04B 1/38; H04M 1/00

(52) U.S. Cl. 455/557; 455/575.2

(57) ABSTRACT

An audio detection apparatus connects to a panel socket on a host case, and supports AC 97/Azalia earphones and microphones. The apparatus comprises a panel header connecting to the panel socket, a control circuit connecting to an earphone output terminal and a microphone input terminal via the panel header and the panel socket and outputs a detection signal. An audio encoding/decoding chip connects to the control circuit and receives a detection signal.

### BACKGROUND OF THE INVENTION

1. Field of the Invention

The present invention relates to a complex audio detection apparatus, and more particularly to a detection apparatus for connecting to a sound socket in a computer case and supporting AC 97 and Azalia earphone and microphone sockets.

2. Description of the Prior Art

Modern personal computers provide numerous multimedia applications to users, such as playing CDs, streaming music, and other home entertainment devices. Moreover, personal computers connect to USBs, audio jacks, HDD LEDs, power LEDs, etc., via the panel headers of computer motherboards.

However, generally, there are two standards for audio jacks of computers, AC 97 (the previous standard) and Azalia (a new standard). In addition, for audio jacks, the new standard substitutes for the previous standard in audio codecs, and there are different uses between the pins of a new standard and the pins of a previous standard. Therefore, the described panel headers with one standard cannot simultaneously support the described audio jacks of the two standards.

### SUMMARY OF THE INVENTION

It is the object of the present invention that the detection apparatus supports both AC 97 and Azalia earphone and microphone sockets in a computer case for further satisfying the requirements of users.

It is another object of the present invention that the detection apparatus can determine whether any earphone or microphone connects to the earphone/microphone socket via its corresponding plug based on a panel socket in the computer case.

In order to achieve the above objects, the present invention provides a complex audio detection apparatus placed on a computer motherboard and connecting to a panel socket in a computer case, wherein the panel socket connects to an earphone output terminal and a microphone input terminal. The complex audio detection apparatus includes a panel header connecting to the panel socket, a control circuit connecting to the earphone output terminal and the microphone input terminal via the panel header and the panel socket, and an audio encoding/decoding chip connecting to the control circuit. Therefore, the control circuit can detect whether any earphone is connected to the earphone output terminal, and whether any microphone is connected to the microphone input terminal, and outputs a detection signal. Then, the audio encoding/decoding chip receives the detection signal for further allowing the operation of microphones/earphones.

### BRIEF DESCRIPTION OF THE DRAWINGS

The above and further advantages of this invention may be better understood by referring to the following description, taken in conjunction with the accompanying drawings, in which:

FIG. 1 is a system block diagram that illustrates the best embodiment of the present invention;

FIG. 2 is a flowchart that illustrates the best embodiment of the present invention;

FIG. 3 is a diagram that illustrates a video frame of the first embodiment of the present invention; and

FIG. 4 is a diagram that illustrates a video frame of the second embodiment of the present invention.

The drawings will be described further in connection with the following detailed description of the present invention.

### DETAILED DESCRIPTION OF THE EMBODIMENTS

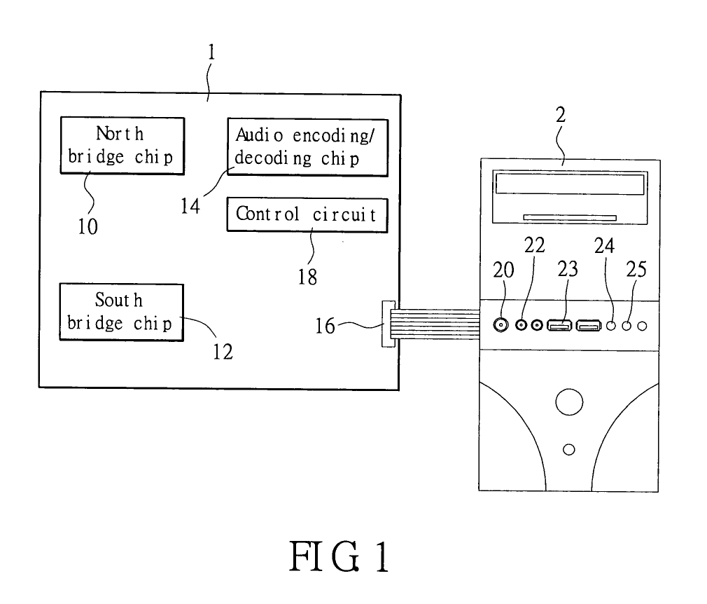

Reference is made to FIG. 1 showing an external diagram for a computer motherboard connecting to a panel socket of a computer case. The computer motherboard 1 includes a north bridge chip 10, a south bridge chip 12, an audio encoding/decoding chip 14, a panel header 16, and a control circuit 18.

The panel header 16 connects to a panel socket (which is not marked) on the computer case 2, wherein the panel socket connects to an earphone output terminal 20, a microphone input terminal 22, a USB 23, an HDD LED 24, and a power LED 25. Both the panel header 16 and the panel socket include 15 pins at either side. Moreover, the earphone output terminal 20 is an AC (audio codec) 97 or Azalia earphone socket, and the microphone input terminal 22 is an AC 97 or Azalia microphone socket.

Otherwise, the panel header 16 detects whether an earphone (which is not shown) is connected to the earphone output terminal 20 and whether a microphone (which is not shown) is connected to the microphone input terminal 22, via the control circuit 18, and the control circuit 18 further transmits detection signals to the audio encoding/decoding chip 14 so as to determine whether to close another microphone connecting to the computer motherboard 1.

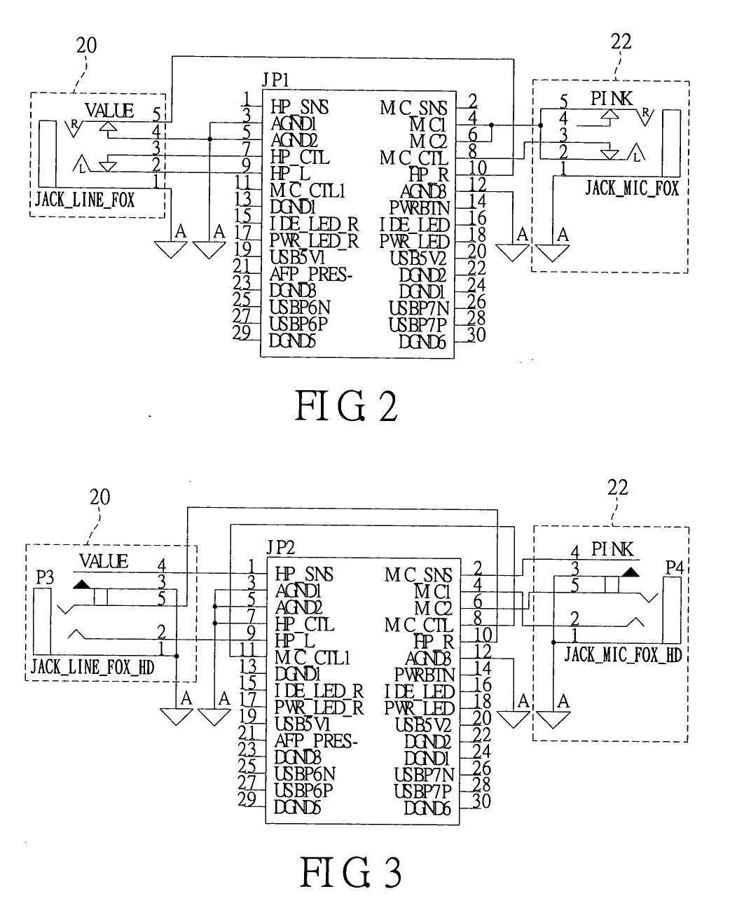

Reference is made to FIG. 2 which shows a diagram of a panel socket JP1 connecting to an AC 97 earphone/microphone. If no earphone is connected to the earphone output terminal 20 via its corresponding plug, for the earphone output terminal 20, the third pin will connect to the second pin, and the fourth pin will connect to the fifth pin. If an earphone is connected to the earphone output terminal 20 via its corresponding plug, for the earphone output terminal 20, the third pin will not connect to the second pin, and the fourth pin will not connect to the fifth pin. As well as the microphone input terminal 22, if no microphone is connected to the microphone input terminal 22 via its corresponding plug, the third pin will connect to the second pin, and the fourth pin will connect to the fifth pin. If a microphone is connected to the microphone input terminal 22 via its corresponding plug, the third pin will not connect to the second pin, and the fourth pin will not connect to the fifth pin.

Reference is made to FIG. 3 that shows a diagram for a panel socket JP2 connecting to an Azalia earphone/microphone. For the earphone output terminal 20, the second and fifth pins respectively connect to the left and right audio channels for further outputting audio signals, and both the third and fourth pins are detection pins that detect whether any earphone is connected to the earphone output terminal 20 via its corresponding plug. If no earphone is connected to the earphone output terminal 20 via its corresponding plug, the third pin will not connect to the fourth pin. If an earphone is connected to the earphone output terminal 20 via its corresponding plug, the third pin will connect to the fourth pin, and the third pin will connect to the ground. Therefore, the control circuit 18 can only determine whether an earphone is connected to the earphone output terminal 20 via its corresponding plug according to the fourth. As well as the microphone input terminal 22,

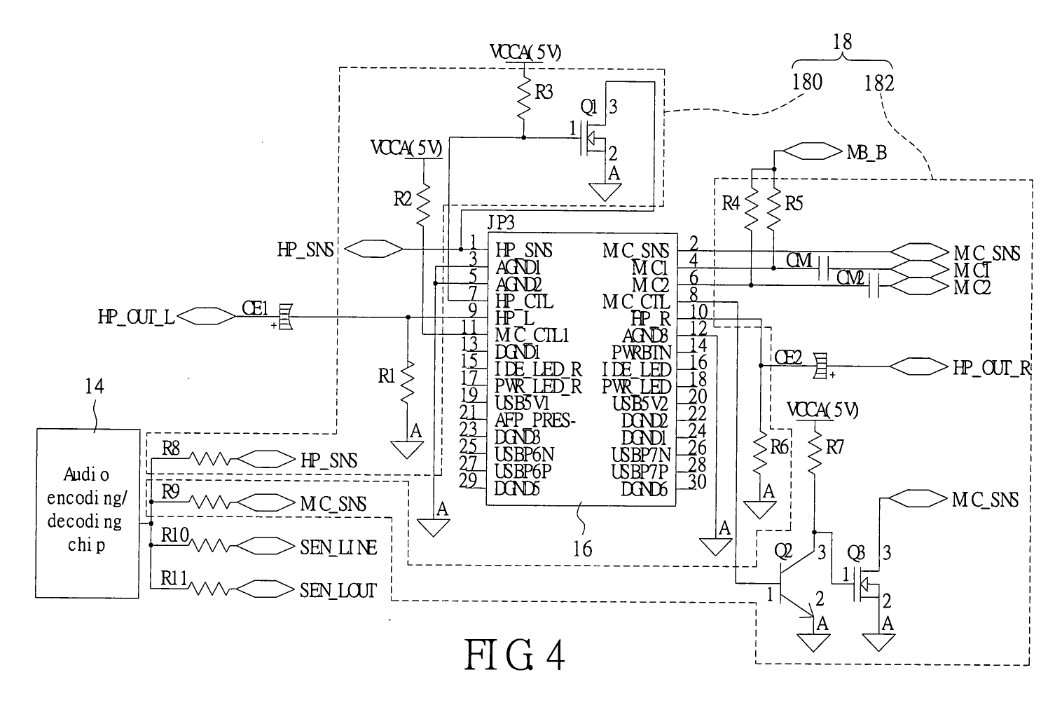

Reference to FIG. 1 and FIG. 4, a diagram of the present invention is shown. The complex audio detection apparatus of the present invention is placed on the computer motherboard 1 and is connected to the panel socket on the computer cell 2, which is connected to the earphone output terminal 20 and the microphone input terminal 22. The complex audio detection apparatus includes a panel header 16, a control circuit 18 and an audio encoding/decoding chip 14. The panel header 16 is connected to the panel socket in FIG. 2 or FIG. 3 to support AC 97/Azalia earphones and microphones.

The control circuit 18 respectively connects to the earphone output terminal 20 and the microphone input terminal 22 via the panel header 16 and the panel socket. The control circuit 18 can then detect whether an earphone is connected to the earphone output terminal 20 via a corresponding plug, and whether a microphone is connected to the microphone input terminal 22 via a corresponding plug. A detection signal is then outputted by the control circuit 18. Moreover, the audio encoding/decoding chip 14 is connected to the control circuit 18 for further receiving the detection signal.

The control circuit 18 includes an earphone detection unit 180 and a microphone detection unit 182. The earphone detection unit 180 includes a first MOS transistor Q1, voltage-divided resistances R1 and R3, and a first detection resistance R8. The earphone detection unit 180 is connected to the audio encoding/decoding chip 14 and the earphone output terminal 20 via the panel header 16 and the panel socket. The first MOS transistor Q1 includes a first gate end, a first source end, and a first drain end, wherein the first source end connects to the ground, the gate end is connected to the voltage-divided resistances R1 and R3, and the first drain end is connected to the first detection resistance R8.

Alternatively, the microphone detection unit 182 can include a switch transistor Q2, a second MOS transistor Q3, shunt resistances R4 and R5, and a second detection resistance R9. The detection unit 182 is connected to the microphone input terminal 22 via the panel header 16 and the panel socket, and the audio encoding/decoding chip 14. The switch transistor Q2 includes a base end, a collector end, and an emitter end, wherein the base end is connected to the shunt resistances R4 and R5, and the emitter end is connected to the ground. The second MOS transistor Q3 includes a second gate end, a second source end, and a second drain end, wherein the second gate end is connected to the collector end of the switch transistor, the source end connects to the ground, and the second drain end is connected to the second detection resistance R9.

In FIG. 2 and FIG. 4, the panel header 16 is connected to the panel socket JP1. The earphone output terminal 20 (an AC 97 earphone socket) and the microphone input terminal 22 (an AC 97 microphone socket) do not provide any pins to determine whether an earphone or microphone plug is plugged into the earphone output terminal 20 or the microphone input terminal 22. However, if the first detection resistance R8 or the second detection resistance R9 is connected to the ground, the complex audio detection apparatus can determine whether any earphone is connected to the earphone output terminal 20 via the earphone plug, or whether any microphone is connected to the microphone input terminal 22 via the microphone plug.

In the earphone output terminal 20, the second and fifth pins respectively connect to the left and right audio channels. However, if an earphone is not connected to the earphone output terminal 20, the third pin is connected to the second pin in the earphone output terminal 20, and the seventh and ninth pins are short in the panel header 16. Then, in the earphone detection unit 180, the VCCA (5V) is divided by the voltage-divided resistances R1 and R3, the first MOS transistor Q1 is cut off, and the first detection resistance R8 does not connect to the ground. If an earphone is connected to the earphone output terminal 20, the second pin dose not connect to the third pin in the earphone output terminal 20, and the seventh and ninth pins are open in the panel header 16. Then, in the earphone detection unit 180, the VCCA (5V) supplies power to the gate end of the first MOS transistor Q1 via the voltage-divided resistances R3 for further opening the first MOS transistor Q1. Then, the first detection resistance R8 is connected to the ground so the audio encoding/decoding chip 14 can determine whether any earphone is connected to the earphone output terminal 20.

Furthermore, the second and fifth pins are used to transmit audio signals from the microphone input terminal 22 to the computer motherboard 1. If no microphone is connected to the microphone input terminal 22, the second pin is connected to the third pin. In this case, the sixth and eighth pins are short in the panel header 16, and the MB_B (5V) supplies power to the switch transistor Q2 via the shunt resistances R4 and R5 so as to open the switch transistor Q2, cut off the second MOS transistor Q3 and cut off the conduction between the second detection resistance R9 and the ground. If a microphone is connected to the microphone input terminal 22, the second pin dose not connect to the third pin in the microphone input terminal 22. In this case, the sixth and eighth pins are open in the panel header 16 so as to cut off the switch transistor Q2, open the second MOS transistor Q3 and link up the second detection resistance R9 and the ground. Therefore, the audio encoding/decoding chip 14 can determine whether any microphone is connected to the microphone input terminal 22 via the corresponding plug.

In FIG. 3 and FIG. 4, the earphone output terminal 20 is an Azalia earphone socket, and the microphone input terminal 22 is an Azalia microphone socket. The detection circuit 18 can support the detection for plugging any corresponding plug into the earphone output terminal 20 or the microphone input terminal 22.

First, the panel header 16 is plugged into the panel socket JP2. In the earphone output terminal 20, the second pin is connected to the left audio channel, and the fifth pin is connected to the right audio channel, wherein audio signals are delivered from the computer motherboard 1 to the earphone output terminal 20 or the microphone input terminal 22 via the audio channels. In the microphone input terminal 22, both the second and fifth pins deliver audio signals from the microphone input terminal 22 to the computer motherboard 1.

If no earphone is connected to the earphone output terminal 20 via its corresponding plug, the third pin will not connect to the fourth pin in the earphone output terminal 20, and the earphone output terminal 20 is connected to the ground via the seventh pin of the panel socket JP2. Therefore, the first MOS transistor Q1 is cut off, and the first detection resistance R8 does not connect to the ground. If an earphone is connected to the earphone output terminal 20 via its corresponding plug, the third pin will not connect to the fourth pin in the earphone output terminal 20, the first MOS transistor Q I will be cut off, and the first detection resistance R8 will connect to the ground based on the third pin connecting to the ground.

If no microphone is connected to the microphone input terminal 22 via its corresponding plug, the third pin will not connect to the fourth pin in the microphone input terminal 22, the switch transistor Q2 will open based on the resistance R2, the second MOS transistor Q3 will be cut off, and the second detection resistance R9 will not connect to the ground. If a microphone is connected to the microphone input terminal 22 via its corresponding plug, the second MOS transistor Q3 will be cut off, and the second detection resistance R9 will connect to the ground according to the third pin connected to the fourth pin in the microphone input terminal 22.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A complex audio detection apparatus placed on a computer motherboard connecting to a panel socket on the computer case, wherein an earphone output terminal and a microphone input terminal plug into the panel socket, comprising:
a panel header for plugging into the panel socket;
a control circuit for connecting to the earphone output terminal and the microphone input terminals via the panel header and the panel socket and outputting a detection signal; and
an audio encoding/decoding chip for connecting to the detection circuit and receiving the detection signal;
wherein, the control circuit detects whether an earphone is plugged into the earphone output terminal, and whether a microphone is plugged into the microphone input terminal, and combines the standards of AC97 and Azalia.

2. A complex audio detection apparatus according to claim 1, wherein both the panel header and the panel socket include 15 pins at either side.

3. A complex audio detection apparatus according to claim 2, wherein the earphone output terminal is an AC 97 earphone socket, and the microphone input terminal is an AC 97 microphone socket.

4. A complex audio detection apparatus according to claim 2, wherein the earphone output terminal is an Azalia earphone socket, and the microphone input terminal is an Azalia microphone socket.

5. A complex audio detection apparatus according to claim 4, wherein both the earphone output terminal and the microphone input terminal respectively include a detection pin.

6. A complex audio detection apparatus according to claim 1, wherein the control circuit comprises:
an earphone detection unit comprising a first MOS transistor, a shunt resistance and a first detection resistance, wherein the earphone detection unit is connected to the earphone output terminal via the panel header and panel socket, and the audio encoding/decoding chip.

7. A complex audio detection apparatus according to claim 6, wherein the first MOS transistor comprises a first gate end, a first source end, and a first drain end, wherein the first source end connects to a ground, the first gate end connects to the shunt resistance, and the first drain connects to the first detection resistance.

8. A complex audio detection apparatus according to claim 1, wherein the control circuit comprises:
a microphone detection unit comprising a switching transistor, a second MOS transistor, a parallel resistance and a second detection resistance, wherein the microphone detection unit connects to the microphone input terminal via the panel header and panel socket, and the audio encoding/decoding chip.

9. A complex audio detection apparatus according to claim 8, wherein the switching transistor comprises a base end, a collector end and an emitter end, and the second MOS transistor comprising a second gate end, a second source end, and a second drain end, wherein, the base end connects to the second gate end, the second source end connects to the ground, and the second drain end connects to the second detection resistance.

10. A complex audio detection apparatus according to claim 1, wherein the panel socket further connects to a USB, an HDD LED and a power LED.
